(19) United States
(12) Patent Application Publication
(10) Pub. No.: US 2026/0366651 A1
(43) Pub. Date: Nov. 19, 2026

(54) NON-METAL PIPE - FOR IMPROVED PIPE BENDING

(71) Applicant: Wavin B.V., Schiphol (NL)

(72) Inventors: Henricus Josephus Geradus Anna GEURTS, Dedemsvaart (NL); Varun SRINIVAS, Schiphol (NL); Johannes AKKERMAN, Dedemsvaart (NL); Lena MERSCHER, Dedemsvaart (NL)

(21) Appl. No.: 19/133,537

(22) PCT Filed: Nov. 24, 2023
(86) PCT No.: PCT/EP2023/082998

§ 371 Date: May 28, 2025

(30) Foreign Application Priority Data
Nov. 29, 2022 (GB) 2217935.2

(51) Int. Cl. F16L 9/12; B32B 1/08; B32B 27/08; B32B 27/20; B32B 27/32; C08K 3/26; C08K 3/34; C08K 9/04; C08L 23/06

(52) U.S. Cl. CPC F16L 9/12; B32B 1/08; B32B 27/08; B32B 27/20; B32B 27/32; C08K 3/26; C08K 3/34; C08K 9/04; C08L 23/06; B32B 2250/03; B32B 2250/242; B32B 2597/00; C08K 2003/265; C08K 2003/343; C08L 2203/18; C08L 2205/025; C08L 2207/068

(57) ABSTRACT

The disclosure provides a plastic pipe for use in plumbing and being bent manually through 90°, the pipe including: a) a first polyethylene layer having raised temperature resistance polyethylene (PE-RT) forming a longitudinal axis of the pipe; the PE-RT layer having between 5 and 60% by weight of an inorganic filler having an average particle size of particle size (D50) of from 0.5 μm to 40 μm.

### FIELD OF THE INVENTION

The present invention relates to a height, such as a multi-layered pipe as well as to a method of manufacturing the same. In particular, the invention relates to a pipe such as a multi-layered pipe to be used for transportation of hot or cold fluids, for example in a heating, a cooling or a water supply system.

### BACKGROUND TO THE INVENTION

The provision of a water supply in a building, be it either possible drinking water, hot water or water for central heating or HVAC purposes is delivered in pipes. For small buildings and offices these pipes are typically of around 20 mm diameter and in larger buildings such small pipes are present towards the end of the distribution chain. Whether of larger or smaller size such pipes are typically installed manually during a building construction process, or retrofitted to an established building. As such it is more effective in the construction process if pipe can be provided in long lengths which are then bent so as to traverse a particular route within the building. Historically metal pipes have been used, such as pipes made of metal or steel and these can be manually bent and retain their shape. More recently there has been a move to plastics pipes for a variety of reasons, including cost and the environment. Such pipes are readily produced in very long lengths and can be transported on site in large reels unlike with metal pipes. Such pipes are resilience, that is they return to an original form after being bent and as such traverse a given route in a building by having specific joint sections added. This is relatively inefficient. Pipes may alternatively be permanently bent by means of heating bending and cooling pipe. This is inconvenient on site and can be irreproducible, temperatures of over 200 °C typically being required. This has been one of the reasons why plastic pipe with an aluminium layer has been created. Such pipes can be bent without resilient recovery in shape. However, such pipes can be difficult to recycle as they are aplastic/metal composite.

There is therefore a need for a pipe consisting of plastics material which can be manually bent without significant resilient recovery.

Multi-layered plastics pipes have widely replaced single layer metal or plastic pipes, which were formerly commonly used in the building industry. By virtue of combining advantageous properties of the different layers such as e.g. special rigidity, resistance against corrosion and/or efficient manufacturability, they may outperform single layered pipes.

Multi-layered pipes including a barrier layer suited to block the passage of fluids such as air or moisture have been developed. Commonly used barrier layers comprise aluminium or EVOH (ethylene vinyl alcohol). Barrier layers can protect a fluid transported in the pipe against other fluids such as from contaminations in the ground diffusing into the pipe.

A pipe with high strength and temperature resistance as well as displaying the additional barrier properties would appear desirable. However, a problem encountered when attempting to manufacture a multi-layered pipe displaying both reinforcement as well as barrier properties, e.g., by combining the aforementioned pipe including a reinforcement layer with an additional barrier layer is that inter layer bonding and mechanical properties of the pipe deteriorate.

For example, it is known that vapour diffusion through the layers of a multi-layered pipe causes physical defects, which can lead to issues with pipe stability and longevity. Two types of physical defects which have been identified are blistering and bubbling. Blistering is caused by the emergence of small bubbles of air within one or more of the individual layers of a multi-layered pipe due to vapour diffusion from the liquid that the pipe is designed to transport. Bubbling is a similar, yet more serious, condition to that of blistering, as the air bubbles generated as a result of transporting the liquid through a multi-layered pipe are generally bigger than those produced during blistering. A further problem is that the larger bubbles tend to emerge at the interface between two of the layers in the multi-layered pipe, which can cause the layers to rupture or split apart. For example, a Technical Information Sheet 850624 dated January 2013 to Rehau acknowledges that “blistering may occur during operation on the pipe surface”. Both issues with vapour diffusion through the layers of a multi-layered pipe can give rise to defects in the pipe itself which lead to catastrophic failures, particularly when using pipes under pressure and/or temperature.

Nanoclays have previously been found to be useful in the food packaging industry. One of the emerging areas in this field is polymer nanocomposite (PNC) technology, which involves the incorporation of various chemicals and nanoadditives into polymers to improve their inherent properties or to add required functionality. Because the nanoparticles may interact with food components during processing, storage, or distribution and may migrate into food, PNC-based packaging materials require awareness and understanding of their potential impact on human health and the environment. Interest in migration and cytotoxic analysis of PNC has gained considerable momentum in recent years. It is known that clay-containing PNCs comprise 50% of all nanofillers, being nanoclays of either of natural or synthetic origin.

CN112066095 discloses a high stiffness heat-resistant high-density polyethylene pipe comprising a main pipe body and a reinforcing pipe, the production raw material of the main pipe body is a compound heat resistant polyethylene (PE-RT) material, and the pipe material of a poly propylene (PP) corrugated pipe in the reinforcing pipe is ‘PPR’ or ‘PPB’. The use of an inorganic filler is disclosed, if the inorganic filler is talc powder and mica then of 1000-4000 mesh (25 to 5 μm) size is disclosed but not whether the material is retained or passes through that mesh size. The stiff pipe is for use in large diameter wastewater piping.

WO2021165290A1 discloses a multi-layer flexible packaging material comprising a paper layer, an aluminium layer, a nanoclay barrier coating layer, and a sealing layer applied to the surface of the nanoclay barrier coating layer representing the inner surface of the multi-layer flexible packaging material, said multilayer flexible barrier material being deprived of a polyolefin layer, such as a polyethylene (PE), polyethylene terephthalate (PET) or a polypropylene (PP) layer.

US2017029196A1 discloses heat sealable food packaging films, methods for the production thereof, and food packages comprising heat sealable food packaging films. The heat sealable food packaging film includes a humidity-dependent permeable film having a moisture vapor transmission rate that increases with an increase in relative humidity (RH). An outer coating comprises a coating material on at least one surface of the humidity-dependent permeable film. The coating material is selected from a nanoclay dispersed in a poly-vinylidene chloride (PVdC) polymer or a stretchable urethane polymer, a stretchable acrylic polymer, or a combination of stretchable urethane polymer and stretchable acrylic polymer.

DE10120620A1 discloses a multi-layered polyamide plastic pipe for conveying fluid media in heating and sanitary installations which comprises at least one layer which is constituted as a multi-material layer consisting of a polymer with embedded nanoclay processed as a filler element. The presence of several binder layers between the respective layers is required which leads to the increased risk of blistering occurring.

KR20110052265A discloses fuel injection pipe using a nano composite is provided to remarkably reduce the discharged amount of fuel evaporation gas generated when variable fuel is used. A fuel injection pipe using a nano composite comprises a nano composite. The nano composite is formed by mixing engineering plastic 97~99.7% and nanoclay 0.3~3% through extrusion or three-dimensional blow moulding. The engineering plastic is polyamide.

The use of nanoclays in combination with high-density or ultra-high molecular weight polyethylene has therefore not been considered for the transportation of hot or cold fluids in a heating, a cooling or a water supply system, to prevent the issues arising from blistering or bubbling in a multi-layered pipe. It would therefore be advantageous to overcome the problems of the prior art by incorporating a nanoclay material into one of the layers of a multi-layered pipe for reducing gas transport through the layers.

However, whilst multilayered pipes provide a multitude of benefits, as described above, they are particularly prone to resilience recovery upon bending and therefore there is a need for a multilayer pipe consisting of plastics material which can be manually bent without significant resilient recovery.

In the terminology of the present application a pipe consisting of plastics material is a pipe in which no layer is present were the continuous phase is other than a plastic. Hence such pipes may have additional components but in no layer to these additional components provide a continuous phase, that means it is not possible to pass from one side of the pipe to the other without encountering a plastic.

The present invention provides:

A plastics pipe for use in plumbing the pipe comprising:
at least one layer of PE-RT comprising from 30 to 95% PE-RT and an inorganic filler.

The invention is suitable for use in plumbing, namely the system of pipes, tanks, fittings, and other apparatus required for the water supply, heating, and sanitation in a building. The pipes relevant to the present invention are primarily intended for the water supply, specifically of water, whether hot or potable and central heating water.

The invention as claimed is set out in accordance with the appended claims.

The present invention provides a plastic pipe for use in plumbing and being bent manually through 90°, the pipe comprising:
a) a first polyethylene layer comprising raised temperature resistance polyethylene (PE-RT) forming a longitudinal axis of the pipe;
the PE-RT layer comprising between 5 and 60% by weight of an inorganic filler having an average particle size of particle size (D50) of from 0.5 μm to 40 μm.

The plastic pipes of the invention are suitable for being bent manually through 90° and in doing so retaining the structural integrity and suitability for use in plumbing applications. In practical terms this means capable of withstanding a difficult operating pressure of at least 70 k Pa up to 700 k Pa. This may be quantified in that the pipe according to the present invention, after being bent manually through 90° (as described herein) may have a burst pressure of at least 2 MPa, preferably at least 6 MPa mor preferably at least 7 MPa. The burst test is conducted under room temperature according to ASTM D1599-18 standard.

This can be used to differentiate the present invention over plastic pipe which may simply be bent but fails to retain its structural integrity. Plastic pipe according to the present invention is capable of being bent and retaining its structural integrity at ambient temperature (taken as 20 °C). The pipe according to the present invention has the advantage that have to having been so bent not only does it retain its structural integrity what the pipe retains the bend when that unrestrained. This may be quantified, as described in the method below by having less than a 5° relaxation of a 90° bend after two weeks. This differentiates the present invention from other by-products which either require heating and cooling, such as over 200 °C, more typically over 400 °C before being capable of being efficiently bent manually and/or which being bent at ambient temperature provide extensive micro-cracking (often evidenced by a white coloration) which reduces the structural integrity of the pipe and/or that the pipe provides more than 5° relaxation of a 90° bend after 24 hours, preferably after two weeks.

The preferred inorganic fillers for use in the present invention are Talc—Mg3Si4O10(OH)2 and Calcium Carbonate—CaCO3. Both these fillers reduce the resilient recovery of bent pipe enabling a bend to be maintained, such as is useful for subsequent installation of a pipe in a plumbing system. Inorganic fillers are preferred as these are inherently not resilient, inorganic fillers are preferred as they do not become admixed with the polymer in which they are present, such as when a masterbatch is prepared. Inorganic fillers are relatively high surface area are preferred, although nanoscale materials appear less effective in modifying elastic recovery.

The pipe of the present invention may preferably further comprise, b) an ultra-high-molecular-weight polyethylene (UHMWPE) layer disposed around the first PE-RT layer. This provides a tougher pipe, such as being less susceptible to penetration and with low moisture permeability.

The pipe of the present invention may further comprise, c) an ultra-high-molecular-weight polyethylene (UHMWPE) layer disposed within the first PE-RT layer. This provides shielding of the water supply from any solubilisable components in the PE-RT layer and also reduces gas permeability.

The pipe of the present invention may further comprise a, d) second PE-RT) layer and d1) disposed outside the previously claimed layer b) or d2) inside the previously claimed later c). This enables each PE-RT layer to be tailored for optimal performance. For example, one layer may be tailored to provide low gas permeability whereas another layer may be tailored to retain shape after bending. The mixing of additives into a single layer is not necessarily synergistic, whereas providing separate layers with separate functionality, such as to give an overall layer thickness equivalent to that of a single thicker layer may give a combined greater efficiency, for example in these two attributes.

In the present invention at least one of the layers further comprises a nanoclay material for reducing gas transport through the layers. This is advantageous as gas transport, such as in the form of water, into a layer comprising an inorganic filler may give rise to some hydration or solubilisable should and of that filler and reduce the lifetime of the pipe and/or because migration of filler components into the supply water.

In the present invention at least one of the layers not comprising inorganic filler comprises a nanoclay material for reducing gas transport through the layers. This separation of layers as previously mentioned enables an overall great improvement in properties and simplifies processing.

In the present invention and innermost PE-RT layer a) may be surrounded by UHMWPE layer b) which is turn surrounded by a PE-RT d1) comprising a nanoclay material for reducing gas transport through the layers.

In such a construction the nanoclay may be present in UHMWPE layer c). This can for example enable both PE-RT layers to comprise filler.

In the present invention the nanoclay present in a particular layer may be present an amount of up to 10 wt. % of the respective layer in which it is located. This level provides effective reduction in gas permeability, such as in a level between 2% and 10%. Critically high levels may be disadvantageous in that components may leach from the layer, such as into the water supply.

In the present invention the thickness of the first PE-RT layer a) is in the range 1.3 to 7.2 mm. this provides a suitable range such that manual bending is practical.

In the present invention the thickness of the second PE-RT layer b) is in the range 0.1 to 0.9 mm, particularly when this layer is disposed on the outer side of the pipe to the second layer the additional volume of the outer layer enables this layer to be made relatively thinner and still be effective.

In the present invention the thickness of the UHMWPE layer is in the range 0.1 to 0.7 mm. thick layers are disadvantageous as UHMWPE is particularly resilient and mitigates against pipe bending and thinner layers are less effective in terms of mechanical strength and reducing moisture transport.

In the present invention the UHMWPE layer is formed from a UHMWPE tape and that layer optionally comprises two layers of tape with one layer on top of the other. This is more effective than co-extrusion is a difference in melting point between the UHMWPE and the PE-RT means that coextrusion can be problematic.

In the present invention when a UHMWPE tape is used two layers of tape have an angle of overlap between them of from 40° to 70° degrees, this provides an effective seal and minimises the resilience of this layer in acting against the retention of a bent pipe shape.

The present invention may further comprise a bonding layer disposed between the first PE-RT layer and the UHMWPE layer, and/or a bonding layer disposed between the second PE-RT layer and the UHMWPE layer.

In the present invention the pipe is preferably from metallic aluminium or copper. The present invention is in particular beneficial in that it allows the removal of such conventional metals to enable pipe bending, with retention of bands made, for installation such as in plumbing. Plastic pipe not comprising metallic elements is also more efficiently recycled and avoids the possibility of corrosion of such metals and the ingress of such metals into the water supply.

The pipe according to the present invention may comprise layers which consist of the stated components however, the layer or layers optionally comprising minor additives at less than 5% by weight. Such additives include plasticisers, flame retardant additives, antioxidants, colourants, UV stabilisers. Preferably no one such component is present at more than 2% by weight.

The preferred exemplification of the present invention is an inner first PE-RT layer comprising between 5 and 60% by weight of an inorganic filler having an average particle size of particle size (D50) of from 0.5 μm to 40 μm; a UHMWPE layer; and an outer, second, PE-RT layer comprising a nanoclay material. This this provides an optimal combination of retention of shape upon bending, physical toughness and reduced gas permeability, for a pipe used in plumbing.

In a further aspect of the present invention the invention provides a method of manufacture of a pipe as herein otherwise disclosed. The present invention therefore also encompasses a method of manufacturing a multi-layered polymer pipe, the method comprising the steps of: melt-extruding a first PE-RT layer a) to form a longitudinal axis of the pipe; melt-extruding a UHMWPE layer b) over the first PE-RT layer; and applying a second PE-RT layer d1) over the UHMWPE layer.

The present invention aims at providing a durable multi-layered pipe having good retention upon band but with sufficient resilient flexibility that small degrees of bend, such as up to 25° resilient new recoverable. The pipe of the present invention 50 when comprising the nano clay also provides an adequate oxygen barrier effect by employing a nanoclay material for reducing gas transport through the layers. An important feature of the present invention is the ability for the pipe to be bent with resilient recovery (good morning at small degrees of bend

It has been surprisingly found that a multi-layered pipe having a layer comprising at least one nanoclay material provides for reducing gas transport through the layers of the pipe. The prevention of gases diffusing from the air surrounding the pipe into the liquid medium, especially at high operating temperatures or pressures of the fluid media carried within the pipe, is considered beneficial to prolonging the lifetime of the pipe.

Preferably the nanoclay is dispersed in at least one of the first or second PE-RT layers. Nanoclay materials are known to have excellent oxygen barrier properties to prevent vapour diffusion across the layers of the multi-layered pipe. More preferably the nanoclay is dispersed in the second (outer) PE-RT layer. A nanoclay-containing outer layer of the multi-layered pipe provides for an oxygen barrier layer immediately adjacent to the surrounding environment to maximise the reduction of potential water vapour diffusing across the layers of the multi-layered pipe which may otherwise cause blistering or bubbling.

Preferably the nanoclay is dispersed in the UHMWPE layer. Water uptake by the nanoclays is reduced with an increase in the concentration of the nanoclay when present in the UHMWPE layer. This improvement is attributed to the reduced water absorption of organoclay composites leading to less softening and plasticization of the UHMWPE polymer layer, resulting in better wear resistance.

Preferably the nanoclay is present in amount of at least 0.5 wt. % of the respective layer in which it is located, preferably 1.0 wt. %, preferably 1.5 wt. %, preferably 2.0 wt. %, preferably 2.5 wt. %, preferably 3.0 wt. %, preferably 3.5 wt. %, preferably 4.0 wt. %, preferably 4.5 wt. % or preferably 5.0 wt. %. Preferably the nanoclay is present in amount of up to 5 wt. % of the respective layer in which it is located, preferably 5.5 wt. %, preferably 6.0 wt. %, preferably 6.5 wt. %, preferably 7.0 wt. %, preferably 7.5 wt. %, preferably 8.0 wt. %, preferably 8.5 wt. %, preferably 9.0 wt. %, preferably 9.5 wt. %, preferably 10.0 wt. %, preferably 10.5 wt. %, preferably 11.0 wt. %, preferably 11.5 wt. %, preferably 12.0 wt. %. Preferably the nanoclay is present in an amount of up to 10 wt. % of the respective layer in which it is located. The permeability and diffusivity of water vapour through the various layers of a multi-layered pipe are considerably reduced by the incorporation of nanoclays into the polymer matrix at levels of up to 10 wt. % of the respective layer in which it is located.

Preferably the nanoclay is montmorillonite being a hydrated sodium calcium aluminium magnesium silicate hydroxide of the formula (Na, Ca)_{0.33}(Al,Mg)₂(Si₄O₁₀)(OH)₂·nH₂O). Nanoclay materials are known to have excellent oxygen barrier properties to prevent vapour diffusion. The incorporation of nanoclays into polymeric matrixes enhances the mechanical, physical, and barrier properties of polymers. Montmorillonite, kaolinite, and saponite are examples of nanoclays that have been used as fillers in the food systems. Montmorillonite in particular has attracted great interest in the food industry due to its cost effectiveness, availability, simple processability, and significant improvement in performance. Preferably, the nanoclay is Cloisite® Na⁺ which is an unmodified type of nanoclay material

Surface modification of nanoclays also provides for improved compatibility with polymer matrix to which it is embedded.

Preferably, the nanoclay is surface modified with a quaternary ammonium salt. Preferably, the quaternary ammonium salt is a modified dialkyldimethyl, arylalkyldimethyl or diaryldimethyl quaternary ammonium salt having the following general formula:

(CH₃)₂N⁺(R)₂

wherein each R group is, independently, a linear alkyl chain having from 8 to 18 carbon atoms, more preferably from 12 to 16 carbon atoms, or an aryl group having from 6 to 12 carbon atoms, more preferably 6 carbon atoms. Suitable counterions typically include chloride.

Preferably, the alkyl chains of the dialkyl or alkyl portion of the quaternary ammonium salt are of equal chain length. Preferably, such a carbon chain length comprises from 16 or 18 carbon atoms. This appears to improve thermal stability and provides better delamination of the clay when incorporated by mixing in polyethylene.

Preferably, the alkyl chains have hydroxyl end groups in order to improve compatibility with polar clay components, potentially providing shorter mixing times.

Preferably, the aryl group is benzyl. This appears to improve thermal stability such as required for processing of UHMWPE.

Preferably, the nanoclay is selected from one or more of Cloisite® 10A, Cloisite® 15A, Cloisite® 20A, Cloisite® 30B or Cloisite® 93A. Most preferably, the nanoclay is Cloisite® 20A as the use of the cationic surfactant. Cloisite® 20A leads to a reduction in surface energy of the nanoclay material and helps in enhancing wettability in a polymer matrix. In addition, the presence of an aliphatic tail attached to the cationic group results in enhancement of d-spacing or interlayer spacing of the nanoclay layers, thereby improving exfoliation and associated physical properties.

Preferably, the amount of nanoclay present in the at least one of the layers of the multi-layered pipe is based upon the amount or number of cations that can be exchanged by another cation on the surface of the nanoclay mineral, the so-called cation exchange capacity (CEC) of the nanoclay material. It is often expressed in meq/100 g clay, which is numerically equivalent to cmol(+)/kg, where mol(+) represents moles of electrical charge. CEC is measured by displacing all the bound cations with a concentrated solution of another cation, and then measuring either the displaced cations or the amount of added cation that is retained. Barium (Ba²⁺) and ammonium (NH⁴⁺) may be used as exchanger cations.

Preferably, the amount of nanoclay present in the at least one of the layers of the multi-layered pipe is at least 80 meq/100 g of clay, preferably at least 85 meq/100 g of clay, preferably at least 90 meq/100 g of clay, preferably at least 95 meq/100 g of clay, preferably at least 100 meq/100 g of clay. Preferably the amount of nanoclay present in the at least one of the layers of the multi-layered pipe is at most 110 eq/100 g of clay, preferably at most 115 meq/100 g of clay, preferably at most 120 meq/100 g of clay, preferably at most 125 meq/100 g of clay, preferably at most 130 meq/100 g of clay, preferably at most 135 meq/100 g of clay, preferably at most 140 meq/100 g of clay. Preferably, the amount of nanoclay present in the at least one of the layers of the multi-layered pipe is at a concentration of between 90 to 125 meq/100 g of clay. By way of contrast, unmodified Cloisite® Na⁺ clay has a CEC value of 92.6 meq/100 g of clay.

The skilled person will appreciate that multi-layered pipes according to the present invention will vary in size according to the quantity of fluid they are designed to transport or the type of dwelling they are intended for use in, but will preferably have an outer pipe diameter in the range from 15 mm to 90 mm, more preferably in the range from 16 mm to 75 mm. The overall outer wall thickness comprising the various layers of the multi-layered pipes is therefore preferably in the range from 1.5 mm to 9 mm, more preferably 2 mm to 7.5 mm.

Preferably, the thickness of the first PE-RT layer is at least 0.5 mm, preferably at least 0.6 mm, preferably at least 0.7 mm, preferably at least 0.8 mm, preferably at least 0.9 mm, preferably at least 1.0 mm, preferably at least 1.1 mm, preferably at least 1.2 mm, preferably at least 1.3 mm, preferably at least 1.4 mm, preferably at least 1.5 mm, preferably at least 1.6 mm, preferably at least 1.7 mm, preferably at least 1.8 mm, preferably at least 1.9 mm, preferably at least 2.0 mm, preferably at least 2.1 mm, preferably at least 2.2 mm, preferably at least 2.3 mm, preferably at least 2.4 mm or preferably at least 2.5 mm. Preferably the thickness of the first PE-RT layer is at most 6.5 mm, preferably at most 6.6 mm, preferably at most 6.7 mm, preferably at most 6.8 mm, preferably at most 6.9 mm, preferably at most 7.0 mm, preferably at most 7.1 mm, preferably at most 7.2 mm, preferably at most 7.3 mm, preferably at most 7.4 mm, preferably at most 7.5 mm, preferably at most 7.6 mm, preferably at most 7.7 mm, preferably at most 7.8 mm, preferably at most 7.9 mm, preferably at most 8.0 mm, preferably at most 8.1 mm, preferably at most 8.2 mm, preferably at most 8.3 mm, preferably at most 8.4 mm or preferably at most 8.5 mm. Preferably the thickness of the first PE-RT layer is in the range 1.3 mm to 7.2 mm. This is good because the first PE-RT layer, the inner layer of pipe, is made as thick as possible in order to allow for the outer layer (the second PE-RT layer) of the multi-layered pipe to be as thin as possible. Also, it is preferred that a thinner outer layer helps with compatibility with certain exterior fittings.

Preferably, the thickness of the second PE-RT layer is at least 0.1 mm, preferably at least 0.2 mm, preferably at least 0.3 mm, preferably at least 0.4 mm, preferably at least 0.5 mm, preferably at least 0.6 mm, preferably at least 0.7 mm or preferably at least 0.8 mm. Preferably the thickness of the second PE-RT layer is at most 0.5 mm, preferably at most 0.6 mm, preferably at most 0.7 mm, preferably at most 0.8 mm, preferably at most 0.9 mm, preferably at most 1.0 mm, preferably at most 1.1 mm, preferably at most 1.2 mm, preferably at most 1.3 mm, preferably at most 1.4 mm or preferably at most 1.5 mm. Preferably the thickness of the second PE-RT layer is in the range 0.1 mm to 0.9 mm. The thickness of the second PE-RT layer is selected to be as thin as possible so that in scenarios where the nanoclay layer is present in this layer, it is easier for the second PE-RT layer (outer) to be compatible with certain exterior fittings.

Preferably, the thickness of the UHMWPE layer is at least 0.1 mm, preferably at least 0.2 mm, preferably at least 0.3 mm, preferably at least 0.4 mm or preferably at least 0.5 mm. Preferably the thickness of the UHMWPE layer is at most 0.5 mm, preferably at most 0.6 mm, preferably at most 0.7 mm, preferably at most 0.8 mm, preferably at most 0.9 mm, preferably at most 1.0 mm, preferably at most 1.1 mm, preferably at most 1.2 mm, preferably at most 1.3 mm, preferably at most 1.4 mm or preferably at most 1.5 mm. Preferably the thickness of the UHMWPE layer is in the range 0.1 mm to 0.7 mm.

Preferably the UHMWPE layer comprises a UHMWPE tape or a fibre. A UHMWPE layer comprising a UHMWPE tape or a fibre provides for a thicker reinforcing layer of the multi-layered pipe.

Preferably the UHMWPE tape layer comprises two layers of tape with one layer on top of the other. In this manner, the UHMWPE layer is formed from several layers of UHMWPE tape which increases the strength of the UHMWPE tape while maintaining the overall flexibility of the UHMWPE tape layer itself, as well as that of the multi-layered pipe.

Preferably the two layers of tape have an angle of overlap between them of at least 20° degrees, preferably at least 25° degrees, preferably at least 30° degrees, preferably at least 35° degrees, preferably at least 40° degrees, preferably at least 45° degrees, preferably at least 50° degrees or preferably at least 55° degrees. Preferably the two layers of tape have an angle of overlap between them of at most 60° degrees, preferably at most 65° degrees, preferably at most 70° degrees, preferably at most 75° degrees, preferably at most 80° degrees, preferably at most 85° degrees or preferably at most 90° degrees. Preferably the two layers of tape have an angle of overlap between them of from 40° to 70° degrees. It has been found that when the two layers of tape have an angle of overlap between them in this range then this maximises the strength and flexibility of the UHMWPE tape layer.

Preferably the multi-layered pipe further comprise a bonding layer disposed between the first PE-RT layer and the UHMWPE layer, and/or a bonding layer disposed between the second PE-RT layer and the UHMWPE layer. While not an essential requirement to the present invention, additional bonding layers, whether present between the first PE-RT layer and the UHMWPE layer, and/or between the second PE-RT layer and the UHMWPE layer allow the corresponding first or second PE-RT layer(s) and the UHMWPE layer to more strongly adhere to each other to minimise seam openings between the layers which may be exploited by blistering or bubbling phenomena.

Preferably the nanoclay is dispersed in the bonding layer disposed between the first PE-RT layer and the UHMWPE layer, and/or the nanoclay is dispersed in the bonding layer disposed between the second PE-RT layer and the UHMWPE layer. In this manner, at least one PE-RT layer is located between an interior flow path of the multi-layered pipe and the UHMWPE layer in order to maximise the reduction of potential water vapour diffusing across the layers of the multi-layered pipe which may otherwise cause blistering or bubbling.

Preferably the at least one bonding layer is formed from high density polyethylene (HDPE), HDPE grafted with maleic anhydride (HDPE-g-MA), low density polyethylene (LDPE), LDPE grafted with maleic anhydride (LDPE-g-MA) or combinations thereof. Bonding layers formed from HDPE or LDPE, whether grafted with maleic anhydride or otherwise, provide for improved bonding between successive layers of the first PE-RT layer and the UHMWPE layer, or the second PE-RT layer and the UHMWPE layer.

Preferably, the thickness of the at least one bonding layer is at least 0.1 mm, preferably at least 0.2 mm, preferably at least 0.3 mm, preferably at least 0.4 mm, preferably at least 0.5 mm, preferably at least 0.6 mm, preferably at least 0.7 mm or preferably at least 0.8 mm. Preferably the thickness of the second PE-RT layer is at most 0.5 mm, preferably at most 0.6 mm, preferably at most 0.7 mm, preferably at most 0.8 mm, preferably at most 0.9 mm, preferably at most 1.0 mm, preferably at most 1.1 mm, preferably at most 1.2 mm, preferably at most 1.3 mm, preferably at most 1.4 mm or preferably at most 1.5 mm. Preferably the thickness of the at least one bonding layer is in the range 0.1 to 0.9 mm. More preferably the thickness of the at least one bonding layer is in the range 0.2 mm to 0.6 mm. The thickness of the at least one bonding layer is selected so as to not be too thick, otherwise it affects the long-term performance of the multi-layered pipe. For example, when the at least one bonding layer is an LDPE-based bonding layer it has a lower melting point compared with layers comprised of PE-RT or UHMWPE. In general, the thickness of the at least one bonding layer is at most 10% of the overall pipe diameter.

Preferably the at least one bonding layer is free from ethylene vinyl alcohol (EVOH). EVOH is known to be a strong barrier against oxygen and gas, it is difficult to make and therefore more expensive. The use of EVOH also provides disadvantages in terms of recyclability, and the fact that when it is used additional tie layers are required in order to bond various layers of the pipe together.

Preferably the multi-layered pipe is free from aluminium. A polymeric multi-layered pipe that does not comprise aluminium maintains good flexibility and can therefore be used in a variety of scenarios where flexibility is useful, e.g. to transport liquids around corners.

Preferably the multi-layered pipe has a density of less than 1 g/cm³. This is good because it is cheaper and easier to transport than conventional metal or concrete alternatives.

Accordingly, the invention provides for a multi-layered pipe for conveying hot water in a dwelling, the pipe consisting of concentric layers of polymeric material, the layers being:
an inner first PE-RT layer;
a UHMWPE layer; and
an outer second PE-RT layer comprising a nanoclay material.

A multi-layered pipe comprising a nanoclay-containing outer layer of the multi-layered pipe provides for an oxygen barrier layer immediately adjacent to the surrounding environment to maximise the reduction of potential water vapour diffusing across the layers of the multi-layered pipe which may otherwise cause blistering or bubbling.

Alternatively, the invention provides for a multi-layered pipe for conveying hot water in a dwelling, the pipe consisting of concentric layers of polymeric material, the layers being:
an inner first PE-RT layer;
a UHMWPE layer comprising a nanoclay material; and
an outer second PE-RT layer.

This is good because water uptake by the nanoclays is reduced with an increase in the concentration of the nanoclay when present in the UHMWPE layer. This improvement is attributed to the reduced water absorption of organoclay composites leading to less softening of the UHMWPE polymer layer, resulting in better wear resistance.

Alternatively, the invention provides for a multi-layered pipe for conveying hot water in a dwelling, the pipe consisting of concentric layers of polymeric material, the layers being:
an inner first PE-RT layer;
a first LDPE bonding layer comprising a nanoclay material;
a UHMWPE layer;
a second LDPE bonding layer comprising a nanoclay material; and
an outer second PE-RT layer.

In this embodiment, at least one PE-RT layer is located between an interior flow path of the multi-layered pipe and the UHMWPE layer in order to maximise the reduction of potential water vapour diffusing across the layers of the multi-layered pipe which may otherwise cause blistering or bubbling. Bonding layers formed from HDPE or LDPE, whether grafted with maleic anhydride or otherwise, provide for improved bonding between successive layers of the first PE-RT layer and the UHMWPE layer, or the second PE-RT layer and the UHMWPE layer.

Alternatively, the invention provides for a multi-layered pipe for conveying hot water in a dwelling, the pipe consisting of concentric layers of polymeric material, the layers being:
an inner first PE-RT layer;
a LDPE bonding layer;
a UHMWPE layer; and
an outer second PE-RT layer comprising a nanoclay material.

This is good because water uptake by the nanoclays is reduced with an increase in the concentration of the nanoclay when present in the UHMWPE layer. This improvement is attributed to the reduced water absorption of organoclay composites leading to less softening and plasticization of the UHMWPE polymer layer, resulting in better wear resistance. In addition, at least one PE-RT layer is located between an interior flow path of the multi-layered pipe and the UHMWPE layer in order to maximise the reduction of potential water vapour diffusing across the layers of the multi-layered pipe which may otherwise cause blistering or bubbling. Bonding layers formed from HDPE or LDPE, whether grafted with maleic anhydride or otherwise, provide for improved bonding between successive layers of the first PE-RT layer and the UHMWPE layer, or the second PE-RT layer and the UHMWPE layer.

Preferably, a portion of the UHMWPE layer may be dispersed in at least one of the first or second PE-RT layers. In scenarios when the UHMWPE layer comprises a UHMWPE tape or a fibre, preferably the UHMWPE tapes or fibres are dispersed in at least one of the first or second PE-RT layers to form a matrix. The skilled person will appreciate that in scenarios when a portion of the UHMWPE layer may be dispersed in at least one of the first or second PE-RT layers, the nanoclay may still be dispersed in at least one of the first or second PE-RT layers or dispersed in the UHMWPE layer in accordance with a first embodiment of the invention. In this manner, at least one of the first or second PE-RT layers of the multi-layered pipe may therefore further comprise a mixture of UHMWPE tapes or fibres and at least one nanoclay material.

Accordingly, a second embodiment of the invention relates to a method of manufacturing a multi-layered polymer pipe according to any preceding claim, the method comprising the steps of:
melt-extruding a first PE-RT layer to form a longitudinal axis of the pipe;
melt-extruding a UHMWPE layer over the first PE-RT layer; and
applying a second PE-RT layer over the UHMWPE layer.

Such a method is considered to be cheaper and easier to carry out in order to manufacture a multi-layered pipe according to a first embodiment of the present invention because i) fewer layers are required to form the multi-layered pipe, ii) those that are required can easily bond and adhere together due to the similar chemical nature of the individual layers, and iii) the entire process can be carried out using existing technology.

Preferably the method of manufacturing a multi-layered polymer pipe comprises the additional steps of:
applying a bonding layer over the first PE-RT layer prior to melt-extruding the UHMWPE layer; and/or
applying a bonding layer over the UHMWPE layer prior to applying the second PE-RT layer.

The incorporation of one or more additional bonding layers improves the bonding between the existing layers of the multi-layered pipe, to increase the overall strength and flexibility of the multi-layered pipe while simultaneously maximising the reduction of potential water vapour diffusing across the layers of the multi-layered pipe.

The PE-RT polymer is resilient and allows considerable elastic deformation. In some uses it is desirable that the multi-layered polymer pipe of the present invention is deformable, such as in bending, a typical requirement in applications, but it does not show significant resilient recovery upon bending. The resilience of the multi-layered pipe of the present invention is therefore preferably reduced. Reduction of resilience may be conveniently achieved by the use of fillers, which can be termed bulk fillers. However, the use of nanoclay (a functional filler) and its beneficial effects, as described above, can be adversely affected by the introduction of other fillers, by a filler is meant a physical particulate in addition to the polymer. It is therefore preferable to limit the resilience (elastic recovery) of the multi-layered pipe of the present invention without providing additional solids materials to the UHMWPE layer. It has been found that the desired characteristics can be achieved by adding a filler to the PE-RT composition. However, it has been found that not all fillers are suitable and certainly not as equally effective in combination with nano-clay.

A filler, that is a material of larger particle size than a nanoclay filler, for example being of particle size (D₅₀) 0.5 μm or greater, preferably less than 40 μm, more preferably in the range 1μ to 6 μm. Larger particles at higher filler levels lead to weaker polymer composite. Such a filler may be referred to as a bulk filler to differentiate it from the nano-clay which, whilst different in particle size can be considered as acting technically as a filler, all be it a functional filler having desirable effects. The person skilled in the art does not normally consider the (expensive) functional components such as a nanoclay as a filler/bulk filler as that is not its function.

In the present invention inorganic fillers are preferred as any dissolution into the water supply, such as for potable water has intrinsically lower toxicity and thermal stability is intrinsically higher particularly given that low levels of decomposition at elevated temperature over time can reduce the structural integrity of a pipe or increase the release of potential toxins into water.

Preferred inorganic fillers suitable for inclusion in the PE-RT layer(s) of the present invention includes:
Talc—Mg3Si4O10(OH)2; Calcium Carbonate—CaCO3, such as in the form of chalk;
Kaolinite—Al2Si2O5(OH)4;
Wollastonite—CaSiO3; Mica muscovite—KAl₂(Si₃AlO₁₀)(OH)₂; Mica phlogopite—KMg₃(AlSi₃O₁₀)(OH)₂; Glass beads or fibre—SiO₂; Calcium Silicate—Ca₂SiO₄, such as diatomaceous earth and Barium sulphate—BaSO₄.

The preferred inorganic fillers are Talc—Mg3Si4O10(OH)2 and Calcium Carbonate-CaCO3 such as in the form of chalk.

The most preferred filler is Talc as this provides the greatest reduction in resilient recovery of a bent pipe in a pipe comprising a PE/RT layer utilising this filler.

Talc of Type B or C ISO standard for quality (ISO 3262) is preferred, Type D having high loss on ignition provides a weaker polymer compound.

In the present invention a filler may be included at a level of between 5 and 60% by weight in the first (inner) PE-RT layer. A preferred level for reduction in resilient recovery of a bent pipe is between 10 and 45% by filler inclusion weight. Higher levels of inclusion can show a reduction in pipe strength, a more preferred filled inclusion is 20 to 40%.

Alternatively, a filler may be included at a level of between 10 and 60% by weight in a second PE-RT layer disposed around the UHMWPE layer.

The filler may be used in both of the PE-RT layers.

However, a filler incorporated into the PE-RT as an inner layer can potentially come into contact with water in the pipes and the fourth for potable water it can be preferable to have the filler in the second PE-RT layer even if this is less effective.

In terms of the desirable characteristic of a pipe of the invention retaining its deformation after bending (longitudinal bending) it has been found that incorporating the filler in the first (inner) PE-RT layer is the more effective. Incorporating the filler in the second (outer) is also effective in reducing resilient recovery after pipe bending, but less so.

When the nano-clay incorporated in the PE-RT layer it is preferably incorporated in the inner later for reducing gas transport, as moisture, from the contents of the pipe. The presence of filler (i.e. bulk filler with the nano clay is disadvantageous as it increases the gas permeability, the bulk filler is therefore preferably in another PE-RT layer. The bulk filler is therefore preferably place in the outer PE-RT layer.

The layer comprising the nano-clay preferably comprises no other solids component polymeric additive besides the nano-clay. The layer comprising the nano clay preferably consists of polymer and nano clay, optionally we trace additives are less than 5% in total by weight. The layer comprising the filler preferably consists of the filler and polymer, optionally with trace additives at less than 5% in total by weight.

The plastic pipe of the present invention, as herein described, is preferably configured for use with a hot water supply (such as 30 to 80 °C) and therefore capable of withstanding a pressure of more than 1 bar, such as in the range 1 to 8 bar in the temperature range.

### BRIEF DESCRIPTION OF THE DRAWINGS

The description is given with reference to the accompanying drawings where like numerals are intended to refer to like parts and in which:

FIG. 1 represents a cross-sectional view of a multi-layered pipe according to a first embodiment of the invention;

FIG. 2 represents a cross-sectional view of a multi-layered pipe according to an alternative first embodiment of the invention;

FIG. 3 represents a cross-sectional view of a multi-layered pipe according to an alternative first embodiment of the invention;

FIG. 4 represents a cross-sectional view of a multi-layered pipe according to an alternative first embodiment of the invention;

FIG. 5 shows a tool and process for pipe bending, such as used in the test method; and

FIG. 6 shows the methodology for measuring pipe bend relaxation over time as used in the test method.

The following abbreviations have been used extensively throughout the description.

### ABBREVIATIONS

PE-RT: polyethylene of raised temperature resistance;
HDPE: high-density polyethylene;
LDPE: low-density polyethylene;
UHMWPE: ultra-high-molecular-weight polyethylene;
(HD/LD) PE-g-MA: (high-density/low-density) polyethylene-graft-maleic anhydride.

For the avoidance of any doubt, a corresponding definition of each of the acronyms used is provided below.

### DEFINITIONS

PE-RT is a polyethylene (PE) resin in which the molecular architecture has been designed such that a sufficient number of tie chains are incorporated to allow operation at elevated or raised temperatures (RT). Tie chains “tie” together the crystalline structures in the polymer, resulting in improved properties such as elevated temperature strength and performance, chemical resistance and resistance to slow crack growth. Suitable grades of PE-RT include □ Dowlex 2388, Dowlex 2344, Dowlex 2355 and Dowex 2377 ex Dow; Hostalen 4731B ex Hostalen 4131B ex. Lyondell-Basell; Daelim XP 9020 ex Daelim; Hanwha M7037 ex Hanwha; Lucene SP 988 ex LG Chem and Yuclair DX800 ex SKC.

HDPE or polyethylene high-density (PEHD) is a thermoplastic polymer produced from the monomer ethylene. HDPE is known for its high strength-to-density ratio. HDPE pipe does not rust, rot or corrode, and is resistant to biological growth. This means an extended service life and long-term cost savings. The density of HDPE ranges from 0.93 to 0.97 g/cm³. Although the density of HDPE is only marginally higher than that of low-density polyethylene, HDPE has little branching, giving it stronger intermolecular forces and tensile strength (38 MPa versus 21 MPa) than LDPE. The difference in strength exceeds the difference in density, giving HDPE a higher specific strength. It is also harder, more opaque and can withstand somewhat higher temperatures (120 °C/248 °F for short periods). High-density polyethylene, unlike polypropylene, cannot withstand normally required autoclaving conditions. The lack of branching is ensured by an appropriate choice of catalyst (e.g. Ziegler-Natta catalysts) and reaction conditions. HDPE is resistant to many different solvents, so it cannot be glued, pipe joints must be made by welding, but this makes pipes constructed out of HDPE ideally suited for transporting drinking water and waste water (storm and sewage).

LDPE is a thermoplastic also made from the monomer ethylene. LDPE is defined by a density range of 0.917 to 0.93 g/cm³. At room temperature it is not reactive, except to strong oxidizers; some solvents cause it to swell. It can withstand temperatures of 65 °C (149 °F) continuously and 90 °C (194 °F) for a short time. Made in translucent and opaque variations, it is quite flexible and tough. LDPE has more branching (on about 2% of the carbon atoms) than HDPE, so its intermolecular forces (instantaneous-dipole induced-dipole attraction) are weaker, its tensile strength is lower, and its resilience is higher. The side branches mean that its molecules are less tightly packed and less crystalline, and therefore its density is lower. When exposed to consistent sunlight, the plastic produces significant amounts of two greenhouse gases: methane and ethylene. Because of its lower density (high branching), it breaks down more easily than other plastics; as this happens, the surface area increases. Production of these trace gases from virgin plastics increases with surface area and with time, so that LDPE emits greenhouse gases at a more unsustainable rate than other plastics. When incubated in air, LDPE emits methane and ethylene at rates about 2 times and about 76 times, respectively, more than in water.

A UHMWPE is a polyethylene polymer that comprises primarily ethylene-derived units and in some embodiments, the UHMWPE is a homopolymer of ethylene. Optionally, a UHMWPE may comprise additional α-olefins such as, but not limited to, 1-butene, 1-pentene, 1-hexene, 1-octene, 1-decene, 1-dodecene, 4-methyl-1-pentene, and 3-methyl-1-pentene. A suitable UHMWPE may have a weight average molecular weight (Mw) of about 1,500,000 g/mol or greater, about 1,750,000 g/mol or greater, about 1,850,000 g/mol or greater, or about 1,900,000 g/mol or greater. These molecules are several orders of magnitude longer than those of familiar HDPE due to a synthesis process based on metallocene catalysts, resulting in UHMWPE molecules typically having 100,000 to 250,000 monomer units per molecule each compared to HDPE's 700 to 1,800 monomers. Examples of commercially available UHMWPE include MIPLEON™ XM-220, MIPLEON™ XM-330 (both available from Mitsui Chemical), Ticona GUR™ 4170 (available from Celanese, Dallas, TX, USA), UTEC3040 (Braskem), LUBMER™ 5000 and LUBMER™ 5220 (both available from Mitsui Chemical).

Suitable UHMWPE may be in a powder or pellet form and/or have an average particle diameter of about 75 μm or less, about 70 μm or less, or about 65 μm or less. Additionally or alternatively, suitable UHMWPE may have an average particle diameter of 10 μm or greater, 15 μm or greater, 20 μm or greater, or 25 μm greater. Additionally or alternatively, suitable UHMWPE may have an average particle diameter of about 40 μm to about 75 μm, such as about 50 μm to about 70 μm, or about 55 μm to 65 μm. Additionally or alternatively, suitable UHMWPE may have an average particle diameter of about 10 μm to about 50 μm, such as about 15 μm to about 45 μm, about 20 μm to about 40 μm, or about 25 μm to about 30 μm.

Particle size in the present invention is determined by ASTM E2834-12 (2022) suitable equipment is the NanoSight NS300 from Malvern Panalytical®. This is suitable for the nano clay. For larger particles than the nano scale, such as the bulk filler, particle size may be determined using a Mastersizer 3000 Malvern Panalytical®.

Water may be used as the medium for suspending the solid in analysis. Measurement are made at 25 °C unless the method requires otherwise. The preferred particle size measurement is D3,2 unless the method requires otherwise. Plastics particle size may be measured using ASTM D7486-14.

PE-g-MA, structure reproduced below for reference, is a compatibilizer for polymer blends which serves as support for polar to nonpolar substances:

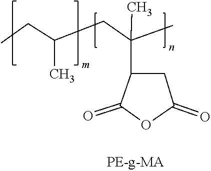

It is known that PE-g-MA introduced or admixed with LDPE/HDPE results in blends which have higher thermal stability. This is a desirable property for the formation of multi-layered pipes.

### DETAILED DESCRIPTION OF THE INVENTION

### Pipe Bending Method and Test.

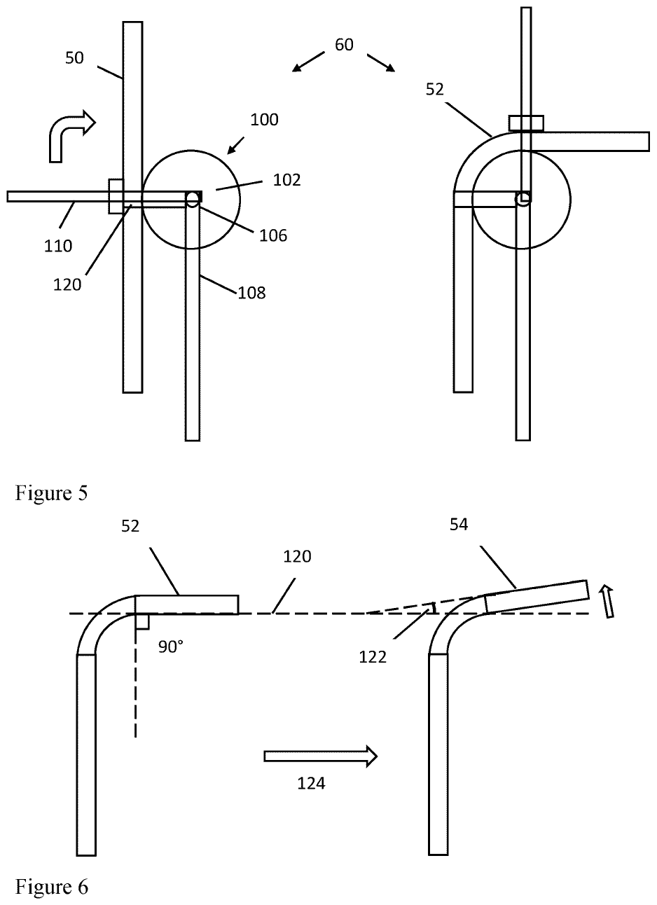

This is illustrated in conjunction with FIGS. 5 and 6.

The present invention utilises a method for determining the retention of a bend in the pipe created by manual bending using a bending tool. The retention of the band depends upon the resilience of the tube question, the ideal tube retains the degree of band which it is bent to I does not recover linearity over time.

A pipe 50, diameter 20 mm, of such construction as described in the previous examples, is secured in a pipe bending tool 100.

The pipe bending tool 100 is of a conventional type known in the industry and comprises two handles 108, 110 which are rotatable around a fulcrum 106. Fulcrum 106 acts as the axle for a wheel 102, which when seen side on has a groove to receive the pipe 50 (not shown on the diagram). The fulcrum also has a bracket 120 extending perpendicular to the first handle 108 and which has a clip to retain the pipe 50 in position against the wheel 102. Upon rotation of the second handle 110, which comprises a forming piece (rectangle shown halfway along the handle), the pipe 50 is retained by the clip of bracket 120 and thus conforms to the circumference (to the inside of the groove) of the wheel, which has a diameter of 12 cm. The handles 108 120 are rotated such as to become co-linear thus executing a 90° bend.

The pipe 50 is now bent pipe 52 and this is placed upon a measuring table having reference line 120 perpendicular to the stem of the pipe 52 such that when the pipe 52 relaxes and deviates from a perpendicular bend to provide pipe 54 the angle of deviation 122 is recorded. This angle of deviation is recorded over time. The experiments are carried out at ambient temperature, taken as 20 °C. The rate of bending provides the bend in around 15 seconds. After bending the angle 122 is recorded: immediately after bending (i.e. the pipe is released from the tool and placed on a flat surface, taking approximately 10 seconds), after 30 minutes, after 24 hours and after 2 weeks. The tube is of length 50 cm, though this is not critical

Unless stated otherwise all pipe examples herein are 20 mm diameter with 3 mm thick walls. Any UHMWPE layer is 0.25 mm thick tape. Any multiple PE-RT layers are of equal thickness. Any bonding layer can be taken as having a thickness of 0.25 mm. unless otherwise stated the PE-RT used is Dowlex 2388.

### Examples 2 to 5 and Reference 1

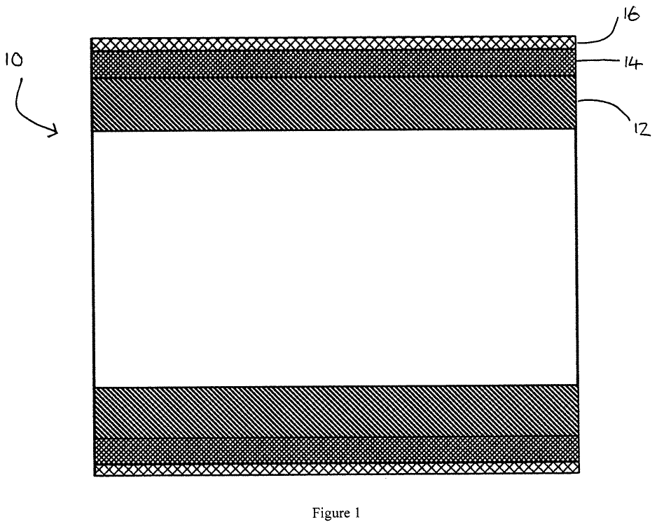

FIG. 1 shows a view of a multi-layered pipe (10) in cross-section according to a first embodiment of the invention. More specifically, FIG. 1 shows a multi-layered pipe (10) having concentric layers of polymeric material being arranged sequentially on top of each other and consisting of a first PE-RT layer (12) forming a longitudinal axis of the pipe (10), a UHMWPE layer (14) containing dispersed UHMWPE tapes/fibres disposed around the first PE-RT layer (12), and a second PE-RT layer (16) comprising a filler material disposed around the UHMWPE layer (14). The nanoclay material in the second PE-RT layer (16) is a surface modified montmorillonite being a hydrated sodium calcium aluminium magnesium silicate hydroxide of the formula (Na,Ca)_{0.33}(Al,Mg)₂(Si₄O₁₀)(OH)₂·nH₂O) whose surface is modified with the quaternary ammonium salt Cloisite® 20A.

Example 1 is produced in 6 variants. With or without filler in each PE-RT layer and when filler is present it is present in either the first OR the second layer and at 11.25% or 22.5% inclusion.

The Talc filler in all examples unless otherwise stated is Granic 282 ™ masterbatch from CRT Group which comprises 75% Talc (D₅₀ 4 μm) in PE and is included to provide, for example 22.5%, filler. Percentages inclusion are by weight of the layer in which the filler is present, unless otherwise stated.

The multi-layered pipe (10) was produced by melt-extruding the first PE-RT layer (12) forming a longitudinal axis of the pipe (10), melt-extruding the UHMWPE layer (14) around the first PE-RT layer (12) and applying the second (outer) PE-RT layer (16) containing the nanoclay around the UHMWPE layer (14).

| Reference 1, | | |
|---|---|---|
| Examples 2 to 5 | Inner PE-RT layer | Outer PE-RT layer |
| 1 | No Filler | No Filler |
| 2 | 11.25% Talc | No Filler |
| 3 | 22.5% Talc | No Filler |
| 4 | No Filler | 11.25% Talc |
| 5 | No Filler | 22.5% Talc |

### Example 6

This is as Example 5 with the nanoclay material in the second PE-RT layer (16) as a surface modified montmorillonite being a hydrated sodium calcium aluminium magnesium silicate hydroxide of the formula (Na,Ca)_{0.33}(Al,Mg)₂(Si₄O₁₀)(OH)₂·nH₂O) whose surface is modified with the quaternary ammonium salt Cloisite® 20A.

### Example 8 and Reference 7

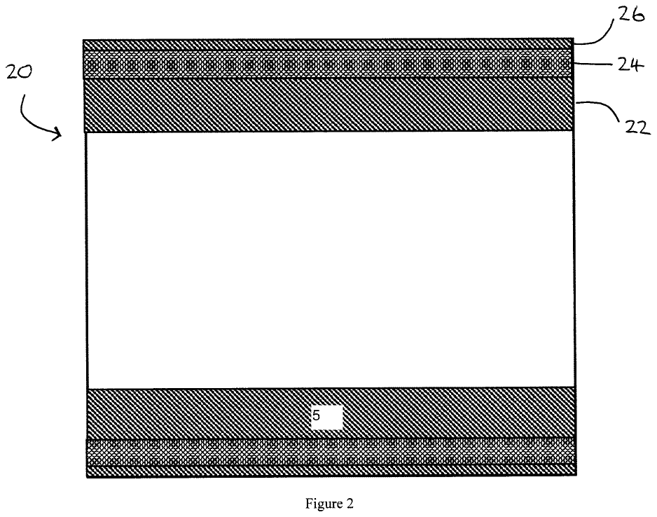

FIG. 2 shows a view of a multi-layered pipe (20) in cross-section according to an alternative first embodiment of the invention. More specifically, FIG. 2 shows reference 7 a multi-layered pipe (20) having concentric layers of polymeric material being arranged sequentially on top of each other and consisting of a first PE-RT layer (22) forming a longitudinal axis of the pipe (20), a UHMWPE layer (24) comprising a nanoclay material disposed around the first PE-RT layer (22), and a second PE-RT layer (26) disposed around the UHMWPE layer (24). The nanoclay material in the UHMWPE layer (24) is a surface modified montmorillonite being a hydrated sodium calcium aluminium magnesium silicate hydroxide of the formula (Na,Ca)_{0.33}(Al,Mg)₂(Si₄O₁₀)(OH)₂·nH₂O) whose surface is modified with the quaternary ammonium salt Cloisite® 20A.

In example 8, the pipe is as Reference 7 with, in the first PE-RT layer (16) Granic 282 masterbatch which comprises 75% Talc in PE is included to provide 22.5% filler.

The multi-layered pipe (20) was produced by melt-extruding the first PE-RT layer (22) forming a longitudinal axis of the pipe (20), melt-extruding the UHMWPE layer (24) containing the nanoclay around the first PE-RT layer (22) and applying the second (outer) PE-RT layer (26) around the UHMWPE layer (24).

### Example 10 and Reference 9

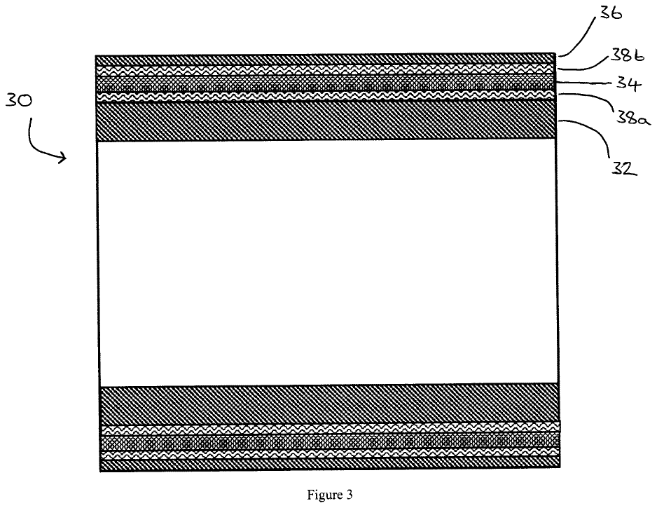

FIG. 3 shows a view of a multi-layered pipe (30) in cross-section according to an alternative first embodiment of the invention. More specifically, FIG. 3 shows reference 9 a multi-layered pipe (30) having concentric layers of polymeric material being arranged sequentially on top of each other and consisting of a first PE-RT layer (32) forming a longitudinal axis of the pipe (30), a first LDPE bonding layer (38a) comprising a nanoclay material disposed around the first PE-RT layer (32), a UHMWPE tape layer (34) disposed around the first LDPE bonding layer (38a), a second LDPE bonding layer (38b) comprising a nanoclay material disposed around the UHMWPE tape layer (34) and a second PE-RT layer (36) disposed around the second LDPE bonding layer (38b). The nanoclay material in each of the first (38a) and second (38b) LDPE bonding layers is a surface modified montmorillonite being a hydrated sodium calcium aluminium magnesium silicate hydroxide of the formula (Na,Ca)_{0.33}(Al,Mg)₂(Si₄O₁₀)(OH)₂·nH₂O) whose surface is modified with the quaternary ammonium salt Cloisite® 20A.

In example 10, the pipe is as Reference 9 with, in the first PE-RT layer (16) Granic 282 masterbatch which comprises 75% Talc in PE is included to provide 22.5% filler.

The multi-layered pipe (30) was produced by melt-extruding the first PE-RT layer (32) forming a longitudinal axis of the pipe (30), applying the first LDPE bonding layer (38a) containing the nanoclay around the first PE-RT layer (32), applying the UHMWPE tape layer (34) by winding layers of UHMWPE tape around the first LDPE bonding layer (38a), applying the second LDPE bonding layer (38b) containing the nanoclay around the UHMWPE tape layer (34) and applying the second (outer) PE-RT layer (36) around the second LDPE bonding layer (38b).

### Example 12 and Reference 11

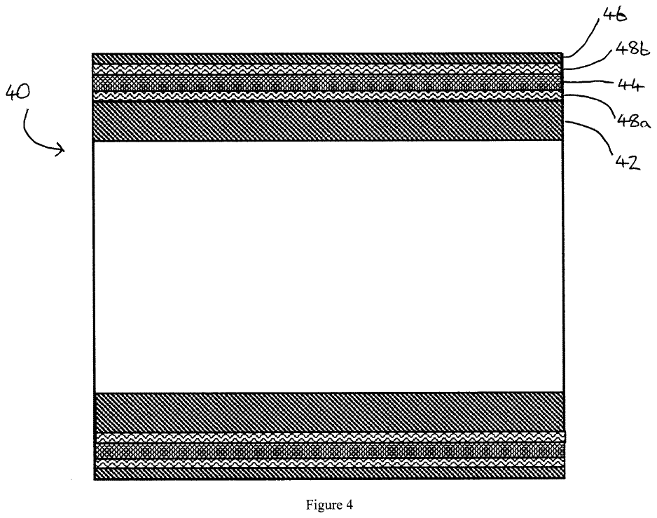

FIG. 4 shows a view of a multi-layered pipe (40) in cross-section according to an alternative first embodiment of the invention. More specifically, FIG. 4 shows reference 11 a multi-layered pipe (40) having concentric layers of polymeric material being arranged sequentially on top of each other and consisting of a first PE-RT layer (42) forming a longitudinal axis of the pipe (40), a first LDPE bonding layer (48a) disposed around the first PE-RT layer (42), a UHMWPE tape layer (44) disposed around the first LDPE bonding layer (48a), a second LDPE bonding layer (48b) disposed around the UHMWPE layer (44) and a second PE-RT layer (46) comprising a nanoclay material disposed around the second LDPE bonding layer (48b). The nanoclay material is a surface modified montmorillonite being a hydrated sodium calcium aluminium magnesium silicate hydroxide of the formula (Na,Ca)_{0.33}(Al,Mg)₂(Si₄O₁₀)(OH)₂·nH₂O) whose surface is modified with the quaternary ammonium salt Cloisite® 20A.

In example 12, the pipe is as Reference 11 with, in the first PE-RT layer (16) Granic 282 materbatch which comprises 75% Talc in PE is included to provide 22.5% filler.

The multi-layered pipe (40) was produced by melt-extruding the first PE-RT layer (42) forming a longitudinal axis of the pipe (40), applying the first LDPE bonding layer (48a) around the first PE-RT layer (42), applying the UHMWPE layer (44) by winding layers of UHMWPE tape around the first LDPE bonding layer (48a), applying the second LDPE bonding layer (48b) around the UHMWPE tape layer (44) and applying the second (outer) PE-RT layer (46) containing the nanoclay around the second LDPE bonding layer (48b).

### Examples 14 to 20 and Reference 13

Reference 13 is a single layer PE-RT pipe. The pipe was produced by melt-extruding the first PE-RT layer forming a longitudinal axis of the pipe.

Examples 14 and 15 represent are with filler in the PE-RT 11.25% or 22.5% inclusion respectively.

The chalk filler is Mastercal 283 of Kilwaughter Lime introduced as masterbatch in PE.

| Reference 13, Examples 14 to 17 | PE-RT |
|---|---|
| 13 | No Filler |
| 14 | 5.6% Talc |
| 15 | 11.25% Talc |
| 16 | 22.5% Talc |
| 17 | 33.75% Talc |
| 18 | 45% Talc |
| 19 | 11.25% Chalk |
| 20 | 22.5% Chalk |

The PE-RT and PE-RT with filler was also made into rectangulat billets of 1 cm by 15 cn by 1 mm test pieces and the following parameters measured using an Instron™ test machine such as a 6800 series machine.

| | | | | | | Charpy |
|---|---|---|---|---|---|---|
| | | Filler | | Yield | Elongation | impact |
| Sample | % Filler | Type | E-mod | strength | at break | strength |
| 13 | 0 | None | 858 | 22.5 | 189 | 65 |
| 15 | 11.25% Talc | Talc | 1450 | 23.9 | 57 | 21 |
| 16 | 22.5% Talc | Talc | 1750 | 24.4 | 45 | 20 |
| 19 | 11.25% Chalk | Chalk | 955 | 21.2 | 86 | 73 |
| 20 | 22.5% Chalk | Chalk | 1070 | 20.2 | 47 | 83 |

### Examples 21 and 22

Example; 21 as Example 13 with a layer of UHMWPE tape on the outer face of the tube. Example; 22 as Example 16 with a layer of UHMWPE tape on the outer face of the tube.

### Pipe Bending, Preliminary Test Results

| Example | | | | |
|---|---|---|---|---|
| pipe | After bending | 30 minutes | 24 hours | 2 weeks |
| 1R | Fail | − | − | − |
| 2 | Pass | Pass | −− | Fail |
| 3 | Pass+ | Pass+ | Pass | Pass |
| 4 | Pass | Pass | −− | Fail |
| 5 | Pass+ | Pass+ | Pass | Pass |
| 6 | Pass | Pass | Pass | Pass |
| 7R | Fail | − | − | − |
| 8 | Pass | Pass | Pass | Fail |
| 9R | Fail | − | − | − |
| 10 | Pass | Pass | Pass | Pass |
| 11R | Fail | − | − | − |
| 12 | Pass+ | Pass | Pass | Pass |
| 13R | Fail | − | − | − |
| 14 | Fail | | | |
| 15 | Pass | Pass | −− | Fail |
| 16 | Pass+ | Pass | Pass | Pass |
| 17 | Pass+ | Pass+ | Pass | Pass |
| 18* | Pass+ | − | − | − |
| 19 | Pass | Fail | − | − |
| 20 | Pass | Pass | Pass | Fail |
| 21R | Fail | − | − | − |
| 22 | Pass | Pass | Pass | Fail |

An acceptable level of elastic, i.e. resilient recovery is taken as 5° or less, greater than this labelled as fail and further measurements are not provided.
R designates reference samples, i.e. comprising no filler.
Pass is 5° or less bending.
Pass+ is no change within error, taken as 1° change in bend.
*Loss of pipe strength on bending.

### SUMMARY OF RESULTS

The initial results show that PE-RT pipe is resilient and upon bending returns, at least to some extent, to its original shape. Similarly multilayered pipes comprising a significant PE-RT layer component are similarly resilient. This is even more so when a UHMWPE layer is included. The presence of nano clay is not an effective material to reduce this resilience. The provision of talc or chalk as fillers reduces resilience and when the pipe is bent the pipe is more likely to retain its curvature. As shown in the test results Talc is more effective than Chalk based upon its weight of inclusion however inclusion of 22.5% by weight of chalk significantly reduces resilient recovery of a bent pipe. Inclusion of 5.6 of talc is however ineffective with the inclusion of 11.25% or more of talc's effective. However most effective range appears to be in the range 22.5% to 33.75% Talc in the PE-RT layer of a pipe. Inclusion of high levels is also effective for pipe bending but appears to influence the resulting strength of the pipe.

1. A plastic pipe for being bent through 90°, the pipe comprising:
a) a first polyethylene layer comprising raised temperature resistance polyethylene (PE-RT) forming a longitudinal axis of the pipe;
the PE-RT layer comprising between 5 and 60% by weight of an inorganic filler having an average particle size of particle size (D50) of from 0.5 μm to 40 μm.

2. The pipe of claim 1 wherein the inorganic filler is selected from one or more of Talc; Calcium Carbonate; Kaolinite; Wollastonite; Mica muscovite; Mica phlogopite; Glass beads or fibre; Calcium Silicate and Barium sulphate—BaSO₄ and mixtures thereof.

3. The pipe of claim 2 wherein the inorganic filler is selected from Talc or calcium carbonate.

4. The pipe according to claim 1, wherein the pipe is free from aluminium metal or copper metal.

5. The pipe of claim 1 further comprising:
b) an ultra-high-molecular-weight polyethylene (UHMWPE) layer disposed around the first PE-RT layer.

6. The pipe of claim 1 further comprising:
c) an ultra-high-molecular-weight polyethylene (UHMWPE) layer disposed within the first PE-RT layer.

7. The pipe of claim 5 further comprising a
d) second PE-RT) layer and
d1) disposed outside the layer b) or
d2) inside the layer c).

8. The pipe of claim 1 in which at least one of the layers further comprises a nanoclay material for reducing gas transport through the layers.

9. (canceled)

10. The pipe of claim 8 in which the innermost PE-RT layer a) is surrounded by UHMWPE layer b) which is in turn surrounded by a PE-RT d1) comprising a nanoclay material for reducing gas transport through the layers.

11.-16. (canceled)

17. The pipe according to claim 5, wherein the UHMWPE layer is formed from a UHMWPE tape and that layer optionally comprises two layers of tape with one layer on top of the other.

18. The pipe according to claim 17, wherein the two layers of tape have an angle of overlap between them of from 40° to 70° degrees.

19. (canceled)

20. (canceled)

21. The pipe according to claim 1, wherein the pipe consists of the layer or a plurality of layers, the layer or layers comprises minor additives at less than 5% by weight.

22. A multi-layered pipe for conveying hot water in a dwelling, the pipe consisting of concentric layers of polymeric material, the layers being:
an inner first PE-RT layer comprising between 5 and 60% by weight of an inorganic filler having an average particle size of particle size (D50) of from 0.5 μm to 40 μm;
a UHMWPE layer; and
an outer, second, PE-RT layer comprising a nanoclay material.

23. A method of manufacturing a multi-layered polymer pipe according to claim 5, the method comprising the steps of:
melt-extruding a first PE-RT layer a) to form a longitudinal axis of the pipe;
melt-extruding a UHMWPE layer b) over the first PE-RT layer; and
applying a second PE-RT layer d1) over the UHMWPE layer.

24. The method according to claim 23, further comprising the additional steps of:
applying a bonding layer over the first PE-RT layer prior to melt-extruding the UHMWPE layer; and/or
applying a bonding layer over the UHMWPE layer prior to applying the second PE-RT layer.
